(19) United States
(12) Patent Application Publication
(10) Pub. No.: US 2025/0249985 A1
(43) Pub. Date: Aug. 7, 2025

(54) Apparatus for attaching a lashing to a container for use in cargo ships

(71) Applicant: Trendsetter Vulcan Offshore, Inc., Houston, TX (US)

(72) Inventors: James V MAHER, Houston, TX (US); Ricky BROWN, Houston, TX (US)

(21) Appl. No.: 18/854,867

(22) PCT Filed: Apr. 11, 2023
(86) PCT No.: PCT/US2023/018153

§ 371 Date: Oct. 7, 2024

Related U.S. Application Data
(60) Provisional application No. 63/328,956, filed on Apr. 8, 2022.

(51) Int. Cl. B63B 25/28

(52) U.S. Cl. CPC B63B 25/28; B63B 2025/285

(57) ABSTRACT

An apparatus for attaching a lashing to a container in a stack includes a lashing having a loop at one end and attached to a tensioner at the other end. The apparatus also includes an elongated body to which the loop is attached by winding. The elongated body has at each of its ends a mechanism capable of interfacing with an interlocking system of a shipping container. In use, the loop of the lashing is located in front of the shipping container and does not interfere with the stack. Two or more apparatus can be used to pre-load a layer of containers from both the starboard and the port sides.

### CROSS-REFERENCE TO RELATED APPLICATIONS

This application claims the benefit of priority to U.S. provisional application Ser. No. 63/328,956 filed on Apr. 8, 2022, which is incorporated herein by reference for any and all purposes.

### FIELD AND BACKGROUND OF THE INVENTION

This disclosure relates generally to apparatus and methods for securing stacked shipping containers, for example, on a cargo ship. This disclosure relates more particularly to apparatus and methods for attaching a lashing to a container.

Cargo ships can accidentally lose large numbers of shipping containers at sea while sailing through heavy seas. As ships become bigger and shipping containers are stacked higher, the customary lashing system design which has been used for many years cannot provide an acceptable level of restraint. The movement of the upper containers that is caused by the ship's pitch and roll under the influence of waves increases. This movement can destabilize the shipping containers because of the higher acceleration levels of the upper containers.

Examples of lashing apparatus for use on cargo ships transporting shipping containers are described in U.S. application Ser. No. 17/316,297, filed on May 10, 2021, which is incorporated herein by reference. In some embodiments, the lashing apparatus may comprise a flat-rack including twist-locks capable of interfacing with an interlocking system of one or more shipping containers, a lashing couplable to the flat-rack and having an end connectable to a clamp, and a track adapted to be secured to another shipping container or a structure of a cargo ship. The clamp may be configured to slide on the track, and the position of the clamp along the track may be adjustable. The lashing may be wrapped or unwrapped around a pair of bollards or fairleads. Each bollard or fairlead may be attached to a pin. The flat-rack may include a plurality of sockets, each sized to receive the pin. As such, the position on the flat-rack of the bollards or fairleads can be adjusted.

In particular, FIG. 1 illustrates a known configuration of a lashing system previously shown in U.S. application Ser. No. 17/316,297. As shown, the lashing system is usable on a cargo ship 20 without lashing bridges. However, the configuration of the lashing system shown in FIG. 1 can alternatively be used on a cargo ship with lashing bridges.

Some lashings (e.g., the lashing 14) are secured between a pair of flat-racks 10 positioned in the stack of containers 22, for example, on top of the stack of containers 22. One of the pair of flat-racks 10 includes a bollard or trunnion 46. The other of the pair of flat-racks 10 includes a tensioner 71. The lashing 14 is attached between the bollard 46 of a flat-rack 10 and the tensioner 71 of another flat-rack 10. All the shipping containers are located between a first wall of shipping containers stacked at a starboard side of the cargo ship and a second wall of shipping containers stacked at a port side of the cargo ship, and thus pushing the containers against one another and rigidifying the stack of containers 22.

Other lashings (e.g., the lashings 26) are secured between a flat-rack 10 and the deck 18 of the cargo ship. For example, the lashings 26 may be simply attached to the flat-rack 10 using a single, and optionally fixed, bollard or trunnion 46 secured to the flat-rack 10. The tensioning of the lashings is performed at the level of the deck 18 (as shown) or the lashing bridge (not shown), where access to the tensioner 73 by operators is available. The stack of container 22 is also rigidified by connecting an end of a first lashing to the deck of the cargo ship so that the first lashing is oriented from the first wall downward and toward the second wall, connecting an end of a second lashing to the deck of the cargo ship so that the second lashing is oriented from the second wall downward and toward the first wall, and applying tension to the first lashing and to the second lashing. Spacers or bumpers 75 are positioned between columns of the stack of container 22 so as to pre-load a layer of containers from both the starboard and the port sides when tension is applied.

FIG. 2 illustrates the tensioners 71 and 73 shown in FIG. 1. The tensioner, as shown, includes a track 70 adapted to be secured to the lashing bridge 16 or deck 18 and a clamp 74 that is configured to slide on the track 70 such that a position of the clamp 74 along the track 70 can be locked using, for example, a pawl and sockets, or any other known means. A portable winch 12A is coupled to the track 70 through a pad-eye 36a and is configured to adjust the position of the clamp 74 along the track 70. The winch 12A is driven by an operator and assists the operator in positioning the clamp 74 in a position where the lashing 26 can placed under tension. In the tensioner, as shown, the lashing 26 is connected to the track 70 via a turnbuckle 34 provided at the end of the lashing 26 and a pad-eye 36 that is mounted on the track 70. As such, the turnbuckle 34 and the pad-eye 36 form a releasable connection. FIG. 2 also illustrates a load pin 38 that can be used to monitor the tension in the lashing 26. Measurements performed by the load pin 38 may be broadcasted to other locations using the Wi-Fi terminal 40.

Despite these advances, there is a continuing need in the art for apparatus usable for attaching a lashing to a container.

### SUMMARY

The disclosure describes a lashing apparatus for stabilizing shipping containers stored on a cargo ship.

The lashing apparatus comprises an elongated body. Each end of the elongated body includes a mechanism capable of interfacing with an interlocking system of one or more shipping containers. The mechanism is configured to partially cover and abut against a front side of a shipping container when the mechanism interfaces with the interlocking system.

The lashing apparatus comprises a lashing having a loop at one end. The loop is attached to the elongated body.

The other end of the lashing is capable of being connected to a lashing bridge or a deck of the cargo ship.

The disclosure describes a method of stabilizing shipping containers stored on a cargo ship, wherein all the shipping containers are located between a first wall of shipping containers stacked at one of a starboard side and a port side of the cargo ship and a second wall of shipping containers stacked at the other of the starboard side and the port side of the cargo ship.

The method comprises providing first and second lashing apparatus as described herein above.

The method comprises applying tension to the lashings of the first and second apparatus.

### BRIEF DESCRIPTION OF THE DRAWINGS

For a more detailed description of the embodiments of the disclosure, reference will now be made to the accompanying drawings, wherein:

FIG. 1 is an elevation view of a portion of a cargo ship including a lashing system;

FIG. 2 is a perspective view of a tensioner included in the lashing system shown in FIG. 1;

FIG. 3 is a perspective view of an apparatus for attaching a lashing to containers;

FIG. 4 is another perspective view of the apparatus shown in FIG. 3;

FIGS. 5A-5C illustrate a sequence of steps for connecting the apparatus shown in FIG. 3 to lower and upper containers.

FIG. 6 is a perspective view of another apparatus for attaching a lashing to a container;

FIG. 7 is another perspective view of the apparatus shown in FIG. 6;

FIGS. 8A-8B illustrate a sequence of steps for connecting the apparatus shown in FIG. 6 to a container.

FIG. 9 is a perspective view of yet another apparatus for attaching a lashing to a container, illustrated connected to the top of the container;

FIG. 10 is a perspective view of the apparatus shown in FIG. 9, illustrated connected to the bottom of the container;

FIG. 11 is a perspective view of yet another apparatus for attaching a lashing to a container, illustrated connected to the top of the container; and

FIG. 12 is a perspective view of the apparatus shown in FIG. 11, illustrated connected to the bottom of the container.

### DETAILED DESCRIPTION

The disclosure describes an apparatus for attaching a lashing to a container. The apparatus comprises an elongated body having at each of its ends a mechanism capable of interfacing with an interlocking system of one or more shipping containers. For example, the mechanism may be capable of interfacing with the interlocking system located at the top of a lower container and the interlocking system located at the bottom of an upper container. Alternatively, the mechanism may only be capable of interfacing with the interlocking system located at the top of a container, or the mechanism may only be capable of interfacing with the interlocking system located at the top of a container. In some cases, it may be advantageous to have the mechanism at one end of the elongated body capable of interfacing with the interlocking system located at the top of a lower container, while the mechanism at the other end capable of interfacing with the interlocking system located at the bottom of an upper container. A lashing terminated by a loop can be attached to the elongated body by winding the loop around a portion of the elongated body.

In some embodiments, the elongated body may be rigid and comprise a beam or equivalent, from which a bollard or equivalent protrudes away from the front side of the container when in use. The mechanism capable of interfacing with the interlocking system of the shipping container(s) may comprise a twist-lock or a pair of twist-locks and a corner casting. Unlike a flat-rack, where the pivoting of the bollard is prevented by attaching the flat-rack at the four corners of a container, the pivoting of the bollard in a beam is prevented using a skirt that is integral to the corner casting. The skirt overlaps with a portion of the front side of the container(s) when the twist-lock interfaces the interlocking system of the container(s). Optionally, the casting may be reinforced using a fin that may prevent the bending of the casting. The fin extends laterally from the front side of the skirt when the twist-lock interacts with the interlocking system, and thus, does not interfere with the stacking of containers.

In some embodiments, the elongated body may be flexible and comprise a segment of rope, chain, or equivalent. The mechanism capable of interfacing with the interlocking system of the shipping container(s) may comprise a container lifting lug, such as a TandemLoc rotary lifting lug or a Dawson lifting lug. Unlike a twist-lock, a container lifting lug extends laterally from the front side of the container when it interacts with the interlocking system. Thus, a container lifting lug does not interfere with the stacking of containers. The segment of rope, chain, or equivalent, may be coupled to the mechanism capable of interfacing with the interlocking system of the shipping container(s) via a shackle. Thus, the segment of rope, chain, or equivalent is located in front of the container when in use.

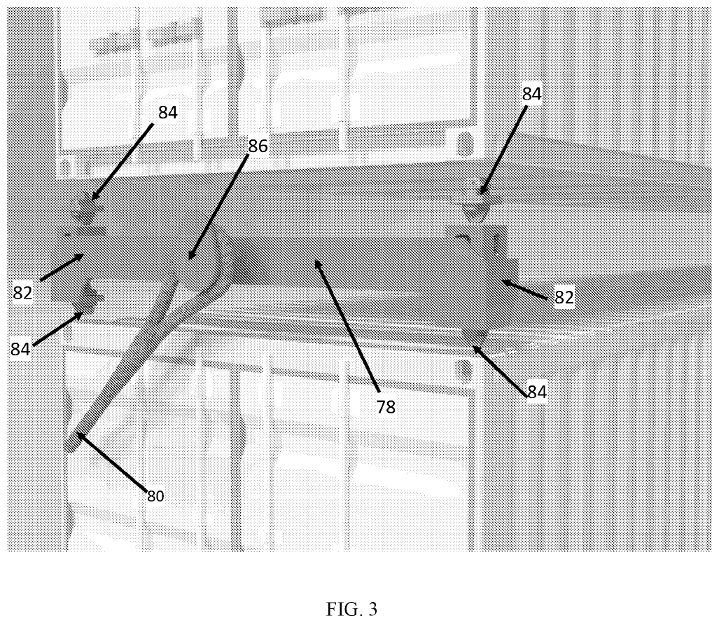

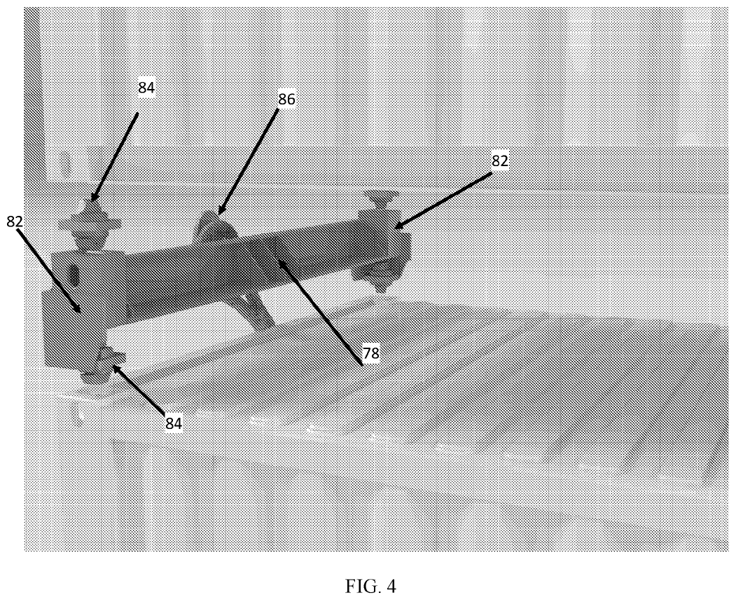

Referring to FIGS. 3 and 4, an apparatus for attaching a lashing 80 to containers comprises a structural, elongated body such as a beam 78, corner castings 82 capable of interfacing with twist-locks 84, and a bollard 86 secured to the beam. The loop at one end of the lashing 80 is wound around the bollard 86. A first releasable connector (e.g., the pad-eye 36 in FIG. 2) can be mounted, directly or indirectly, on a lashing bridge, a lashing tie-rod, or a deck of the cargo ship on a lashing bridge, a lashing tie-rod, or a deck of the cargo ship, and a second releasable connector (e.g., the turnbuckle 34 shown in FIG. 2) can be included at the other end (not shown) of the lashing 80 and adapted to be releasably coupled to the first releasable connector.

The first releasable connector can generally comprise any known rigging hardware useable for releasably connecting the first releasable connector to the second releasable connector, such as an eye, a shackle, a turnbuckle, or a hook. For example, the first releasable connector can include the pad-eye 36 shown in FIG. 2.

The second releasable connector can generally comprise any known rigging hardware useable for releasably connecting the second releasable connector to the first releasable connector, such as an eye, a shackle, a turnbuckle, or a hook, that is capable of releasably connecting an end of the lashing to the first releasable connector. For example, the second releasable connector can include the turnbuckle 34 shown in FIG. 2.

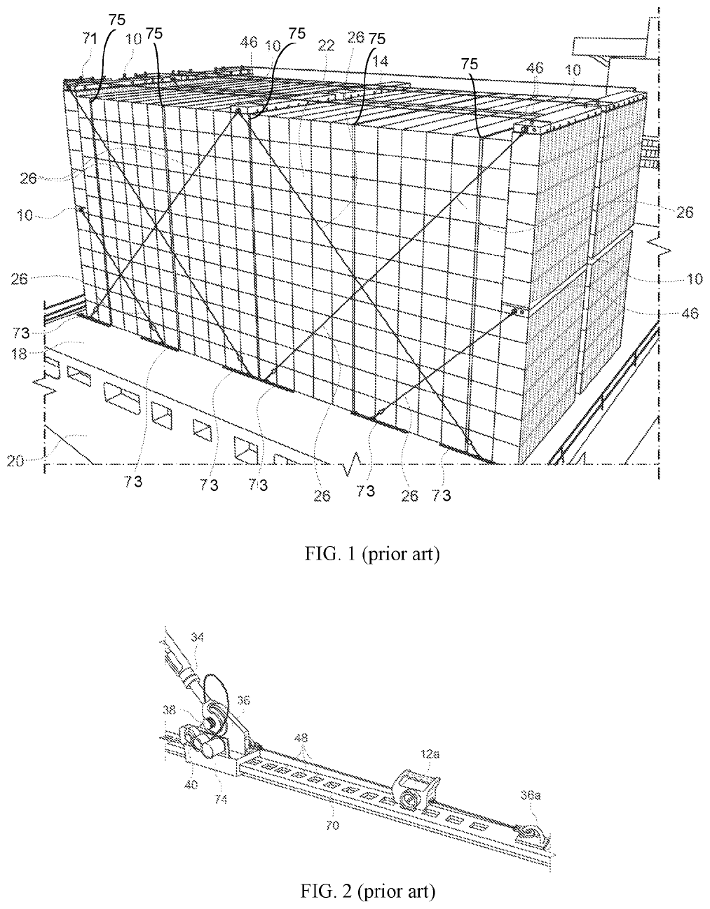

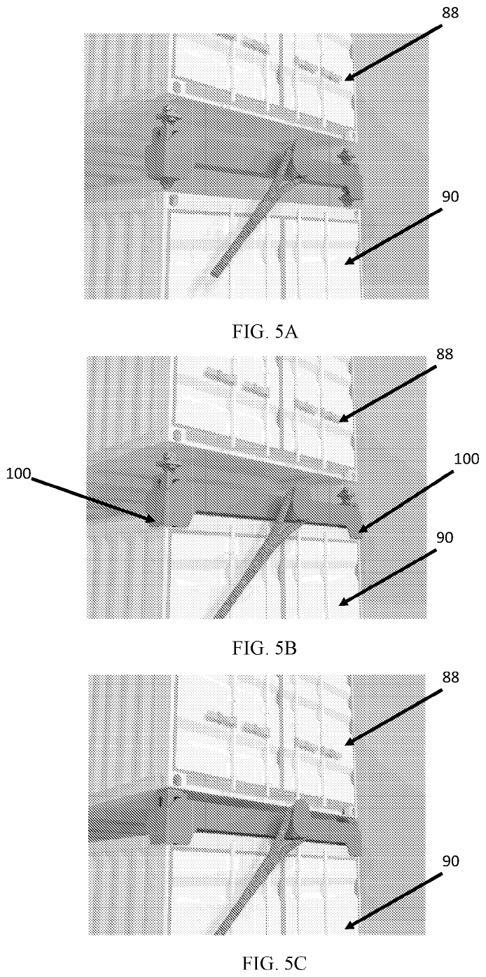

Referring to FIGS. 5A-5C, the apparatus shown in FIGS. 3 and 4 can be secured sequentially to a lower and an upper container. In FIG. 5A, the apparatus is neither secured to lower container 90 nor upper container 88. In FIG. 5B, the apparatus is secured to the lower container 90 via twist-locks (i.e., twist-locks 84 shown in FIGS. 3 and 4) that interface with the interlocking system of the lower container 90, and the skirt 100 of the corner castings of the apparatus (i.e., the corner castings 82 shown in FIGS. 3 and 4) abuts against a corner of the lower container 90. In FIG. 5C, the apparatus is secured to both the lower container 90 and the upper container 88. As such, the apparatus can be positioned in a wall of shipping containers at the starboard and/or port side(s) of the shipping container stack and at a lower height than the top of a column of stacked shipping containers, such as illustrated in FIG. 1, for example. A spacer may be used on the opposite side (i.e., the back side) to avoid the tilting of the upper container 88.

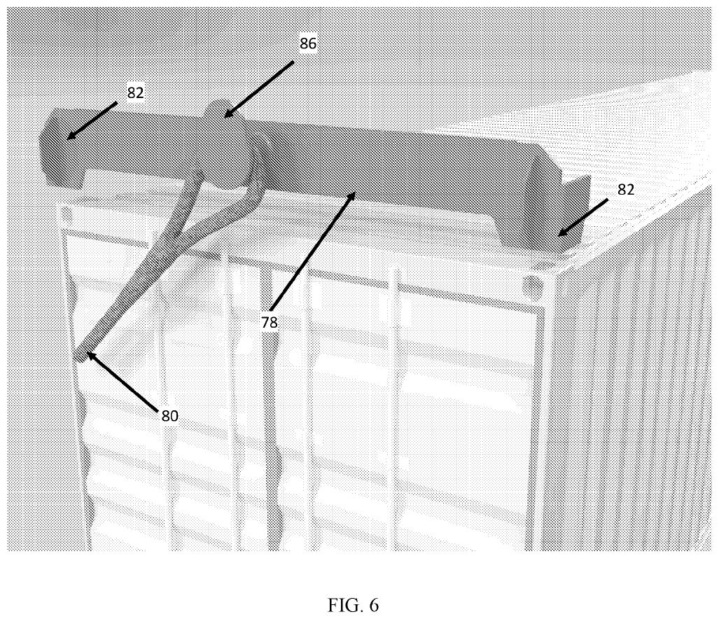

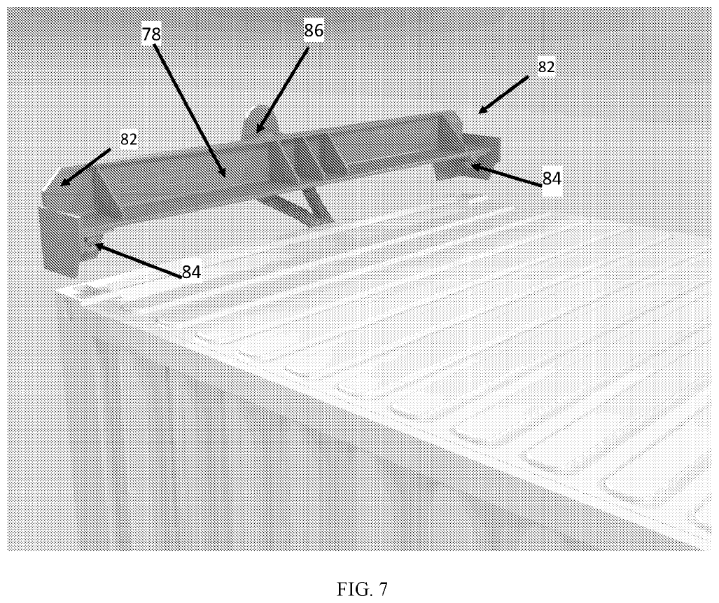

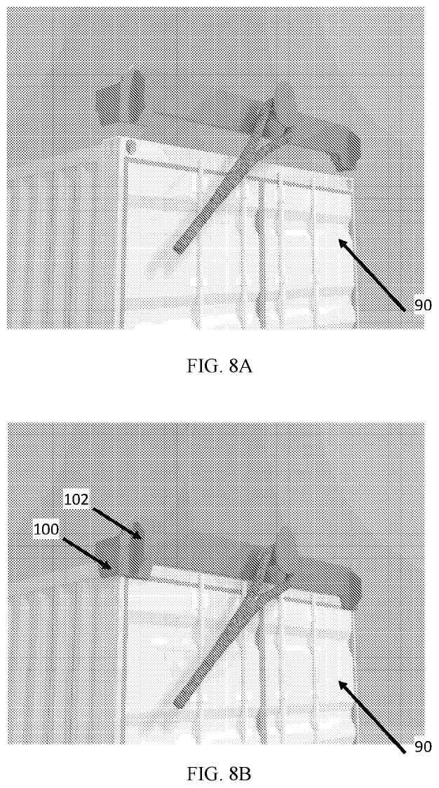

Referring to FIGS. 6 and 7, another apparatus for attaching a lashing 80 to containers is illustrated. The other apparatus is similar to the apparatus shown in FIGS. 3 and 4, except that the apparatus may only be capable of interfacing with the interlocking system located at the top of a lower container 90, as is shown in FIGS. 8A and 8B. As such, the other apparatus can be positioned on top of a wall of shipping containers at the starboard and/or port side(s) of the shipping container stack and at the highest height of the column, such as illustrated in FIG. 1, for example.

Alternatively, the other apparatus can be positioned between walls of shipping containers at the starboard and/or port side(s) of the shipping container stack and at the highest height of the column, such as also illustrated in FIG. 1, for example.

Referring to FIGS. 8A-8B, the apparatus shown in FIGS. 6 and 7 can be secured sequentially to a lower and an upper container. In FIG. 8A, the apparatus is neither secured to lower container 90 nor upper container 88. In FIG. 8B, the apparatus is secured to the lower container 90 via twist-locks (i.e., twist-locks 84 shown in FIGS. 6 and 7) that interface with the interlocking system of the lower container 90, and the skirt 100 of the corner castings of the apparatus (i.e., the corner castings 82 shown in FIGS. 6 and 7) abuts against a corner of the lower container 90. Further resistance may be provided using fins 102.

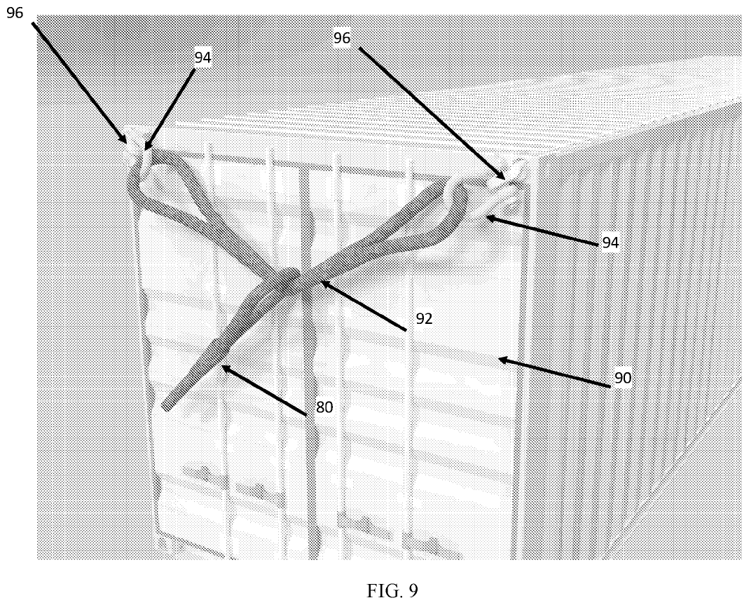

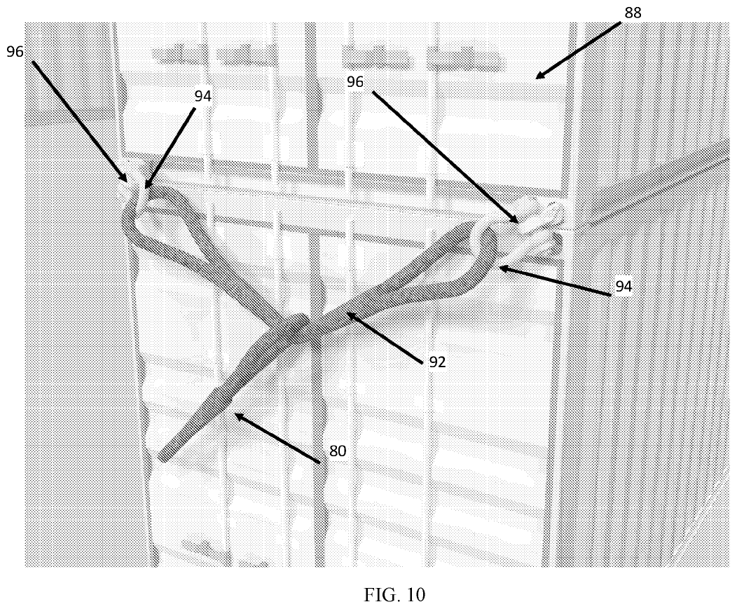

Referring to FIGS. 9 and 10, an apparatus for attaching a lashing 80 to containers comprises an elongated body, such as a segment of rope 92, terminated by shackles 94 at each end. The apparatus also comprises container lifting lugs 96, for example, Dawson lifting lugs, capable of interfacing with the interlocking system of a container. The loop at one end of the lashing 80 is wound around the segment of rope 92 before the container lifting lugs 96 are connected to the container. A first releasable connector (e.g., the pad-eye 36 in FIG. 2) can be mounted, directly or indirectly, on a lashing bridge, a lashing tie-rod, or a deck of the cargo ship on a lashing bridge, a lashing tie-rod, or a deck of the cargo ship, and a second releasable connector (e.g., the turnbuckle 34 shown in FIG. 2) can be included at the other end of the lashing 80 and adapted to be releasably coupled to the first releasable connector.

The container lifting lugs 96 can be connected at the top of a lower container 90, as shown explicitly in FIG. 9, or at the bottom of an upper container 88, as shown explicitly in FIG. 10. As such, the apparatus can be positioned almost anywhere in the shipping container stack. The connections can be made at other locations of one or more containers.

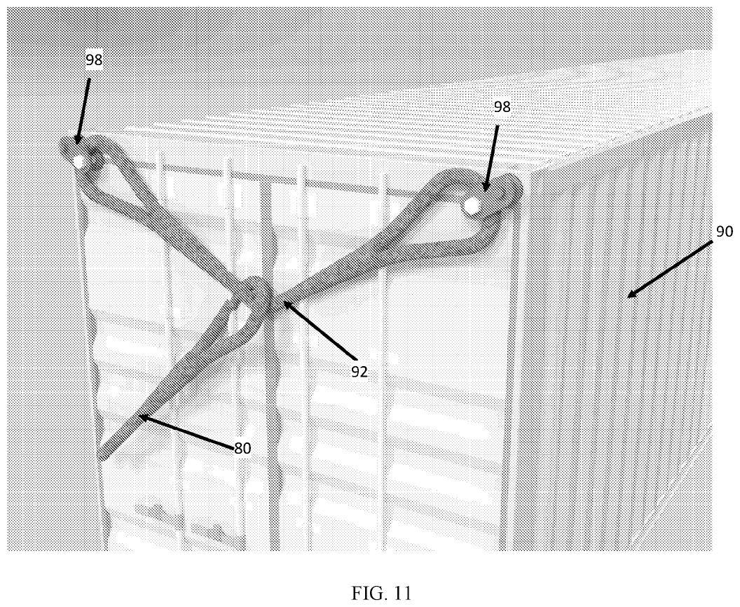

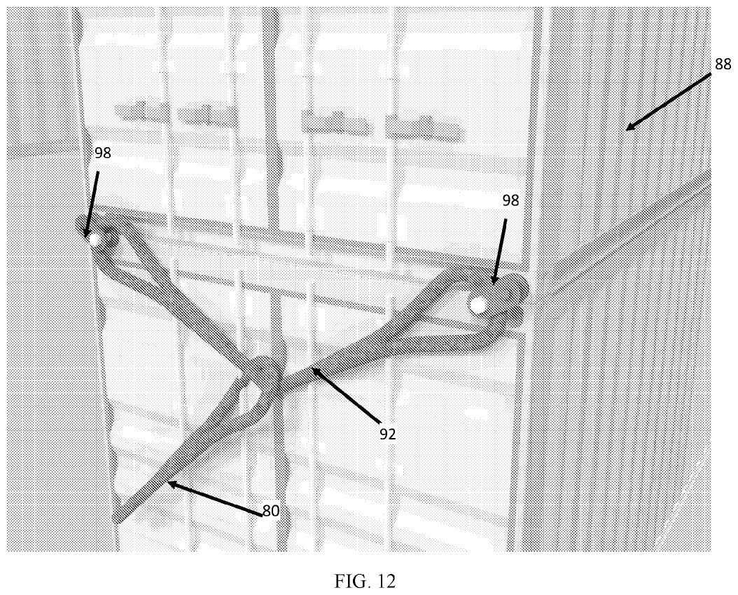

Referring to FIGS. 11 and 12, an apparatus for attaching a lashing 80 to containers comprises an elongated body, such as a segment of rope 92. The apparatus also comprises container lifting lugs 98, for example, TandemLoc rotary lifting lugs, capable of interfacing with the interlocking system of a container. The segment of rope 92 can be connected to the container lifting lugs 98 without shackles because the container lifting lugs 98 integrate the function of the shackles 94 and the container lifting lugs 96 shown in FIGS. 9 and 10. The loop at one end of the lashing 80 is wound around the segment of rope 92 before the container lifting lugs 98 are connected to a container. The apparatus shown in FIGS. 11 and 12 can be used similarly to the apparatus shown in FIGS. 9 and 10. In particular, the container lifting lugs 98 can be connected at the top of a lower container 90, as shown explicitly in FIG. 11, or at the bottom of an upper container 88, as shown explicitly in FIG. 12. The connections can be made at other locations of one or more containers.

In addition to the foregoing, the disclosure also contemplates at least the following embodiments:

### Embodiment 1

Embodiment 1 is a lashing apparatus usable for stabilizing shipping containers stored on a cargo ship.

The lashing apparatus includes an elongated body in the form of a beam having first and second ends, or equivalent. Each of the first and second ends includes a mechanism capable of interfacing with an interlocking system of one or more shipping containers and is configured to partially cover and abut against a front side of a shipping container when the mechanism interfaces with the interlocking system. As such, a lashing can be attached to a protrusion at the front of the beam (i.e., the side of the beam facing the same direction as the front side of the container when in use), and tension can be applied to the lashing without causing the pivoting of the beam.

The lashing apparatus also includes a lashing having first and second ends. The first end of the lashing includes a loop attached to the protrusion of the beam. The second end of the lashing is capable of being connected to a lashing bridge or a deck of the cargo ship, preferably with a releasable connection. For example, the second end of the lashing may be attached to a clamp of a tensioner, which may include a track secured to the lashing bridge or the deck of the cargo ship. The clamp is configured to slide on the track such that a position of the clamp along the track can be locked using, for example, a pawl and sockets or any other known means.

### Embodiment 2

Embodiment 2 is a lashing apparatus as described in embodiment 1, wherein the first end of the lashing is attached to the elongated body by winding the loop around one or more of a bollard attached to a pin, or a fairlead attached to a pin.

### Embodiment 3

Embodiment 3 is a lashing apparatus as described in embodiments 1 or 2, wherein the mechanism includes twist-locks and a vertical skirt extending downward. The skirt is configured to cover and abut against a shipping container when the mechanism interfaces with the interlocking system.

### Embodiment 4

Embodiment 4 is a lashing apparatus as described in embodiment 1 3, wherein each of the first and second ends further includes a vertical fin that extends laterally from the vertical skirt.

### Embodiment 5

Embodiment 5 is a lashing apparatus usable for stabilizing shipping containers stored on a cargo ship.

The lashing apparatus includes a flexible elongated body having first and second ends. For example, the flexible elongated body may comprise a segment of rope, chain, or equivalent. Each of the first and second ends includes a mechanism capable of interfacing with an interlocking system of one or more shipping containers and is configured to partially cover and abut against a front side of a shipping container when the mechanism interfaces with the interlocking system. As such, the flexible elongated body is located in front of the container when in use.

The lashing apparatus also includes a lashing having first and second ends. The first end of the lashing includes a loop attached to the flexible elongated body. The second end of the lashing is capable of being connected to a lashing bridge or a deck of the cargo ship, preferably with a releasable connection. For example, the second end of the lashing may be attached to a clamp of a tensioner, which may include a track secured to the lashing bridge or the deck of the cargo ship. The clamp is configured to slide on the track such that a position of the clamp along the track can be locked using, for example, a pawl and sockets or any other known means.

### Embodiment 6

Embodiment 6 is a lashing apparatus as described in embodiment 5, wherein the first end of the lashing is attached to the elongated body by winding the loop around the elongated body.

### Embodiment 7

Embodiment 7 is a lashing apparatus as described in embodiments 5 or 6, wherein the mechanism extends laterally from the container when it interacts with the interlocking system so that the mechanism does not interfere with the stacking of containers.

### Embodiment 8

Embodiment 8 is a lashing apparatus as described in embodiment 7, wherein the mechanism includes a container lifting lug.

### Embodiment 9

Embodiment 9 is a method of stabilizing shipping containers stored on a cargo ship, wherein all the shipping containers are located between a first wall of shipping containers stacked at one of a starboard side and a port side of the cargo ship and a second wall of shipping containers stacked at the other of the starboard side and the port side of the cargo ship.

The method comprises the step of providing a first lashing apparatus as described in any of embodiments 1 to 8.

The method comprises the step of securing the first lashing apparatus to the first wall by interfacing the first and second ends of the elongated body of the first lashing apparatus with an interlocking system of a first shipping container.

The method comprises the step of partially covering a front side of the first shipping container with the mechanisms of the first and second ends of the elongated body of the first lashing apparatus.

The method comprises the step of abutting the mechanisms of the first and second ends of the elongated body of the first lashing apparatus against the front side of the first shipping container.

The method comprises the step of attaching the first end of a lashing of the first lashing apparatus to the elongated body of the first lashing apparatus.

The method comprises the step of connecting the second end of the lashing of the first lashing apparatus to a lashing bridge or a deck of the cargo ship so that the lashing of the first lashing apparatus is oriented from the first wall downward and toward the second wall.

The method comprises the step of providing a second lashing apparatus as described in any of embodiments 1 to 8.

The method comprises the step of securing the second lashing apparatus to the second wall by interfacing the first and second ends of the elongated body of the second lashing apparatus with an interlocking system of a second shipping container.

The method comprises the step of partially covering a front side of the second shipping container with the mechanisms of the first and second ends of the elongated body of the second lashing apparatus.

The method comprises the step of abutting the mechanisms of the first and second ends of the elongated body of the second lashing apparatus against the front side of the second shipping container.

The method comprises the step of attaching the first end of a lashing of the second lashing apparatus to the elongated body of the second lashing apparatus.

The method comprises the step of connecting the second end of the lashing of the second lashing apparatus to a lashing bridge or a deck of the cargo ship so that the lashing of the second lashing apparatus is oriented from the first wall downward and toward the second wall.

The method comprises the step of applying tension to the lashings of the first and second lashing apparatuses.

### Embodiment 10

Embodiment 10 is a method as described in embodiment 9, further comprising the step of positioning spacers or bumpers between columns of the shipping containers so as to pre-load a layer of containers from both the starboard and the port sides when tension is applied to the lashings of the first and second lashing apparatuses.

While some combinations or sub-combinations of the specific features described in embodiments 1 to 10 may only be described in other paragraphs of the detailed description and/or the drawings, it is contemplated that similar combinations or sub-combinations of these features can be made in any of embodiments 1 to 10 to describe other embodiments even when omitting other aspects described in these paragraph(s) or drawing(s) in these other embodiments. Furthermore, while implementation details of the specific features described in embodiments 1 to 10 may only be described in other paragraphs of the detailed description and/or the drawings, it is also contemplated that these implementation details can qualify these specific features in any of embodiments 1 to 10 to describe other embodiments even when omitting other aspects described in the paragraph(s) or drawing(s) in these other embodiments.

The disclosure is susceptible to various modifications and alternative forms. Specific embodiments thereof are shown by way of example in the drawings and description. It should be understood, however, that the drawings and detailed description thereto are not intended to limit the scope of the invention to the particular form disclosed. However, on the contrary, the intention is to cover all modifications, equivalents, and alternatives falling within the scope of the claims.

What is claimed is:

1. A lashing apparatus for stabilizing shipping containers stored on a cargo ship, comprising:
an elongated body having first and second ends, wherein each of the first and second ends includes a mechanism capable of interfacing with an interlocking system of one or more shipping containers and is configured to partially cover and abut against a front side of a shipping container when the mechanism interfaces with the interlocking system; and
a lashing having first and second ends, wherein the first end of the lashing includes a loop, and wherein the second end of the lashing is capable of being connected to a lashing bridge or a deck of the cargo ship;
wherein the first end of the lashing is attached to the elongated body.

2. The lashing apparatus of claim 1, wherein the elongated body includes a beam having a protrusion.

3. The lashing apparatus of claim 2, wherein the first end of the lashing is attached to the elongated body by winding the loop around one or more of a bollard attached to a pin, or a fairlead attached to a pin.

4. The lashing apparatus of claim 2, wherein the mechanism includes twist-locks and a vertical skirt extending downward, wherein the skirt is configured to cover and abut against a shipping container when the mechanism interfaces with the interlocking system.

5. The lashing apparatus of claim 2, wherein each of the first and second ends further includes a vertical fin that extends laterally from the vertical skirt.

6. The lashing apparatus of claim 1, wherein the elongated body is flexible.

7. The lashing apparatus of claim 6, wherein the elongated body includes a segment of rope.

8. The lashing apparatus of claim 6, wherein the first end of the lashing is attached to the elongated body by winding the loop around the elongated body.

9. The lashing apparatus of claim 6, wherein the mechanism extends laterally from the container when it interacts with the interlocking system so that the mechanism does not interfere with the stacking of containers.

10. The lashing apparatus of claim 9, wherein the mechanism includes a container lifting lug.

11. A method of stabilizing shipping containers stored on a cargo ship, wherein all the shipping containers are located between a first wall of shipping containers stacked at one of a starboard side and a port side of the cargo ship and a second wall of shipping containers stacked at the other of the starboard side and the port side of the cargo ship, the method comprising:
providing a first lashing apparatus including:
a first elongated body having first and second ends, wherein each of the first and second ends includes a mechanism capable of interfacing with an interlocking system of a first shipping container; and
a first lashing having first and second ends, wherein the first end of the first lashing includes a loop;
securing the first elongated body to the first wall by interfacing the first and second ends of the first elongated body with an interlocking system of the first shipping container;
partially covering a front side of the first shipping container with the mechanisms of the first and second ends of the first elongated body;
abutting the mechanisms of the first and second ends of the first elongated body against the front side of the first shipping container;
attaching the first end of the first lashing to the first elongated body;
connecting the second end of the first lashing to a lashing bridge or a deck of the cargo ship so that the first lashing is oriented from the first wall downward and toward the second wall;
providing a second lashing apparatus including:
a second elongated body having first and second ends, wherein each of the first and second ends includes a mechanism capable of interfacing with an interlocking system of a second shipping container;
a second lashing having first and second ends;
securing the second elongated body to the second wall by interfacing the first and second ends of the second elongated body with an interlocking system of the second shipping container;
partially covering a front side of the second shipping container with the mechanisms of the first and second ends of the second elongated body;
abutting the mechanisms of the first and second ends of the second elongated body against the front side of the second shipping container;
attaching the first end of the second lashing to the second elongated body;
connecting the second end of the second lashing to the lashing bridge or the deck of the cargo ship so that the second lashing is oriented from the second wall downward and toward the first wall; and
applying tension to the first lashing and to the second lashing.

12. The method of claim 11, further comprising positioning spacers or bumpers between columns of the shipping containers so as to pre-load a layer of containers from both the starboard and the port sides when tension is applied to the first lashing and the second lashing.
